(19) United States
(12) Patent Application Publication
(10) Pub. No.: US 2015/0028668 A1
(43) Pub. Date: Jan. 29, 2015

(54) Modular Vehicle Unit

(71) Applicant: WWL Vehicle Services Americas, Inc., Woodcliff Lake, NJ (US)

(72) Inventors: Clarence Smith, Belvidere, TN (US); Nantcho Dimitrov, Smyrna, TN (US)

(21) Appl. No.: 14/338,330

(22) Filed: Jul. 22, 2014

Related U.S. Application Data
(60) Provisional application No. 61/858,443, filed on Jul. 25, 2013.

(51) Int. Cl. B60R 16/03

(52) U.S. Cl. CPC B60R 16/03
USPC 307/9.1

(57) ABSTRACT

An apparatus, modular devices, and methods are disclosed. One method comprises receiving electric power at a modular device from a vehicle battery, wherein the modular device has a housing and a circuit protection block accessible through a first opening in the housing; and transmitting the received electric power to one or more external devices via one or more of a plurality of ports accessible through a plurality of second openings formed in the housing.

### CROSS REFERENCE TO RELATED PATENT APPLICATION

This application claims priority to U.S. Patent Application No. 61/858,443 filed Jul. 25, 2013, which is herein incorporated by reference in its entirety.

### BACKGROUND

Users of a vehicle often require a power supply for mobile peripheral devices such as phones, computers, navigation devices, etc. Users generally obtain electric power directly from a car battery, for example, through a cigarette lighter adapter or other electrical connection point. However, users are limited to the electrical connection points integrated in the vehicle by the supplier or original equipment manufacturer (OEM) from the factory. Such factory configurations are not always sufficient for a user's needs. The present disclosure addresses these and other shortcomings.

### SUMMARY

It is to be understood that both the following general description and the following detailed description are exemplary and explanatory only and are not restrictive. Provided are methods and systems for receiving power at a modular device from a vehicle battery.

One method comprises receiving electric power at a modular device from a vehicle battery, wherein the modular device has a housing and a circuit protection block accessible through a first opening in the housing. The received electric power can be transmitted to one or more external devices via one or more of a plurality of ports accessible through a plurality of second openings formed in the housing.

An apparatus can comprise a housing having a plurality of openings formed therein and a plurality of electrical components disposed within the housing, wherein one or more of the plurality of electrical components is in electrical communication with a vehicle battery. A plurality of ports can be configured to receive an electrical connector, wherein the ports are accessible through one or more of the openings formed in the housing. A circuit protection block can be in electrical communication with the one or more of the plurality of ports, wherein the circuit protection block is accessible through one or more of the openings formed in the housing.

A modular device can comprise a vehicle interface configured for receiving electric power from a vehicle battery and a plurality of ports configured to transmit the received electric power to one or more external devices. The modular device can comprise a fuse block that can be configured to electrically protect one or more of the plurality of ports. The modular device can further comprise a housing that can comprise a first opening allowing access to the vehicle interface, a plurality of second openings allowing access to the plurality of ports, and a third opening allowing access to a fuse block.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate aspects and together with the description, serve to explain the principles of the methods and systems:

FIG. 1 a block diagram of an exemplary apparatus;

FIG. 2 is a schematic diagram of the circuitry of the apparatus of FIG. 1;

FIG. 3 is a perspective view of a housing;

FIG. 4 is a perspective view of a housing;

FIG. 5 is a perspective view of a complementary component;

FIG. 6 is a perspective view of a complementary component; and

FIG. 7 is a flow diagram of an exemplary method.

### DETAILED DESCRIPTION

Before the present methods and systems are disclosed and described, it is to be understood that the methods and systems are not limited to specific methods, specific components, or to particular configurations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description. One method can comprise receiving electric power at a modular device from a vehicle battery, wherein the modular device comprises a housing and a circuit protection block accessible through a first opening in the housing. The received electric power can be transmitted to one or more external devices via one or more of a plurality of ports accessible through a plurality of second openings formed in the housing.

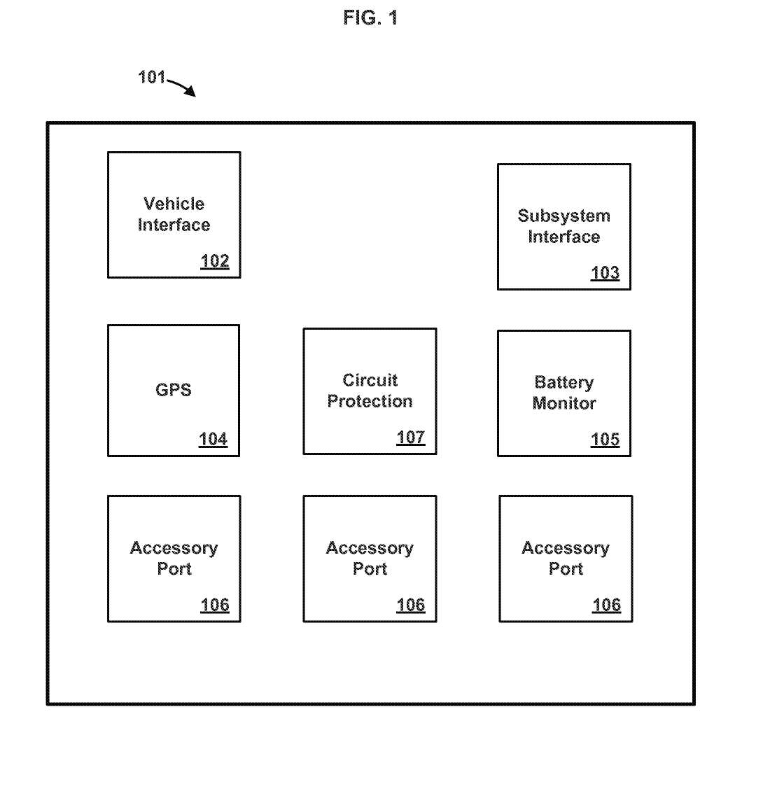

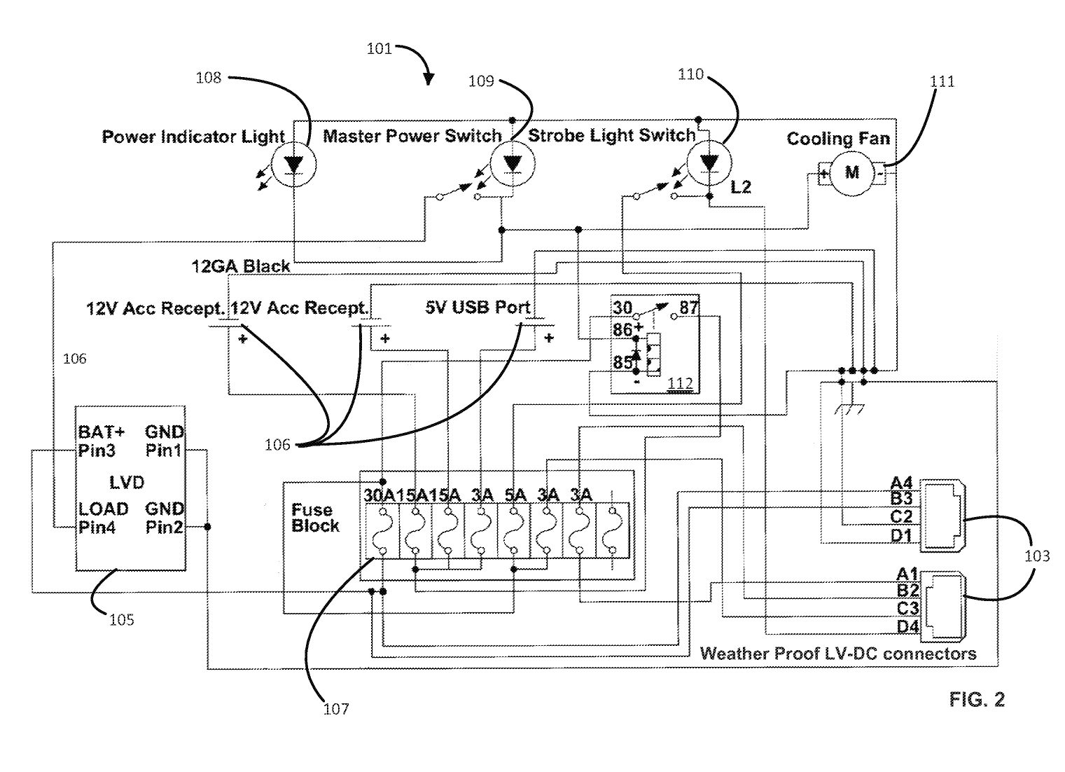

FIGS. 1-2 illustrate exemplary apparatus 101 comprising a modular vehicle unit. The apparatus can be installed in a vehicle. Such vehicles include, but are not limited to, personal and commercial vehicles, motorcycles, transport vehicles, watercraft, aircraft, military and the like. For example, an entire fleet of vehicles can be equipped with the apparatus. In an aspect, all components of the modular vehicle unit can be contained within a single housing. In another aspect, the components can be distributed throughout a vehicle. Each of the components of the apparatus can be separate subsystems of the vehicle, for example, a communications component such as a satellite digital audio radio services (SDARS), or other satellite receiver, can be coupled with an entertainment system of the vehicle.

In an aspect, the apparatus 101 can comprise a vehicle interface 102 to couple the apparatus 101 to a vehicle wiring system. In an aspect, the vehicle interface 102 can comprise one or more wiring harnesses to interface with an existing vehicle wiring harness. In an aspect, the apparatus 101 can receive power from a battery of the vehicle through the vehicle interface 102. The apparatus 101 can comprise a subsystem interface 103 to support one or more subsystems, for example, a strobe light.

The apparatus 101 can comprise a global positioning system (GPS) receiver 104, GPS receiver 104 can receive position information from a constellation of satellites operated by the U.S. Department of Defense. Alternately, the GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range. In an aspect, the GPS receiver 104 can activate on ignition or start of motion. The GPS receiver 104 can go into idle on ignition off or after ten minutes without motion. Time to first fix can be less than 45 seconds, 90% of the time. For example, this can be achieved either through chipset selection or periodic wake-up.

The apparatus 101 can comprise a battery monitor 105. Battery monitor 105 can periodically sample the power level of a vehicle battery and alert a user when the power level drops below a threshold. In another aspect, the methods, systems, and apparatuses provided can utilize a power management scheme ensuring that the vehicle battery is not impaired under normal operating conditions. In another aspect, the apparatus can include battery backup. The battery can be rechargeable. The battery can be user replaceable or non-user replaceable. In one aspect the battery monitor 105 can be a low voltage disconnect.

The apparatus 101 can comprise one or more accessory ports 106. Accessory ports 106 can comprise one or more DC connectors configured to supply electrical power for portable accessories used in or near the vehicle. In an aspect the one or more accessory ports 106 can be configured to be connected to constant power. In another aspect the one or more accessory ports 106 can comprise a universal serial bus socket. In a further aspect, the one or more accessory ports 106 can comprise one or more 12 volt, 15 amp sockets. In an aspect, the one or more accessory ports 106 can comprise one or more 12 volt, 5 amp universal sockets. In an aspect, the one or more accessory ports 106 can comprise one or more 5 volt Universal Serial Bus (USB) ports. In one aspect, the accessory ports 106 can be in communication with one or more other devices, providing power to the one or more devices. In a further aspect, the accessory ports 106 can be in communication with one or more other devices, providing 12 volt power to the one or more devices, which can include, but is not limited to, a Wi-Fi access point, an e-log driver database system, a digital. two radio equipment, a cab camera, a laptop, a tablet, a printer, a scanner, mobile ground penetrating radar equipment, x-ray equipment, geo-systems underground surveying equipment, engineering equipment, surveying equipment, mapping equipment, cellular equipment, cellular devices, mobile defibrillator equipment, mobile medical equipment, navigational equipment, a power inverter, battery powered hand tools, a thermal printer, charger cradles for one or more battery packs (e.g., 12 volt battery pack), DVD equipment, video equipment, camera equipment, POS credit/debit equipment, an air compressor, work lights, a digital compass, back up camera equipment, portable satellite, portable water pump, liquid pump, electric hydraulic pump, mobile jack, fishing trolling motor, fish finder, electric winch, and one or more 12 volt appliances, such as a refrigerator, a coffee pot, a lantern, a vacuum, a heater, a hair dryer, a fan, a blanket, etc.

The apparatus 101 can comprise one or more circuit protection blocks 107 such as fuses, breakers, limiters, and the like to protect the various components of the apparatus 101 and the vehicle in which it is installed. In an aspect, the one or more circuit protection blocks 107 can be configured to protect an external device that is electrically coupled to the apparatus 101. As an example, the one or more accessory ports 106 can be electrically protected by the one or more circuit protection blocks 107.

The apparatus 101 can comprise a power indicator light 108 to indicate that the apparatus 101 is capable of providing power. Power indicator light 108 can be a light emitting diode (LED) light, which can be lit when the apparatus 101 is receiving power from a vehicle battery. In an aspect, the power indicator light 108 can be configured to indicate an operational state of the one or more accessory ports 106.

The apparatus 101 can comprise a master power switch 109, which can allow power to flow throughout the apparatus 101 when in the “on” position. The master power switch 109 can prevent power from flowing throughout the apparatus 101 when in the “off” position.

The apparatus 101 can comprise a switch for activating the subsystem 103. In an example, the apparatus 101 can comprise a strobe light switch 110 for activating one or more strobe lights. The apparatus 101 can comprise the one or more strobe lights. In an aspect, the apparatus 101 can comprise one or more weather proof LV-DC connectors. The one or more strobe lights can connect to the apparatus 101 through the one or more weather proof LV-DC connectors.

The apparatus 101 can comprise one or more cooling fans 111, which can prevent the components in the apparatus 101 from overheating. In an aspect, the one or more cooling fans 111 can be configured to manage the heat within an enclosed portion of the apparatus 101 such as internal to a housing.

The apparatus 101 can comprise a switch 112. In an aspect, the switch 112 can be 12V relay switch. In a further aspect, the switch 112 can work in conjunction with the battery monitor 105 to shut down power from the vehicle battery to the apparatus 101 when the vehicle battery source reaches a threshold. In an aspect, the battery monitor 105 can shut down power from the vehicle battery to the apparatus 101 by causing the switch 112 to open an internal circuit when the threshold is reached. In a further aspect, the battery monitor 105 can cause the switch 112 to close the internal circuit, when the battery monitor 105 determines that the vehicle battery has reached an appropriate level so that power can be received from the vehicle battery to the apparatus 101.

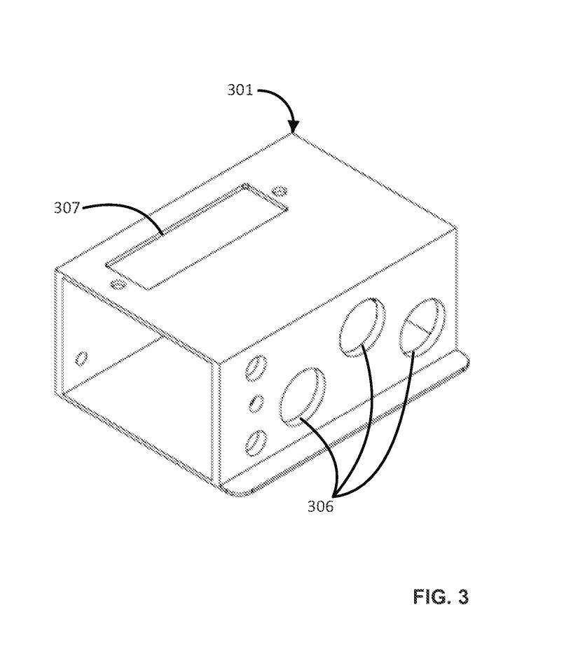

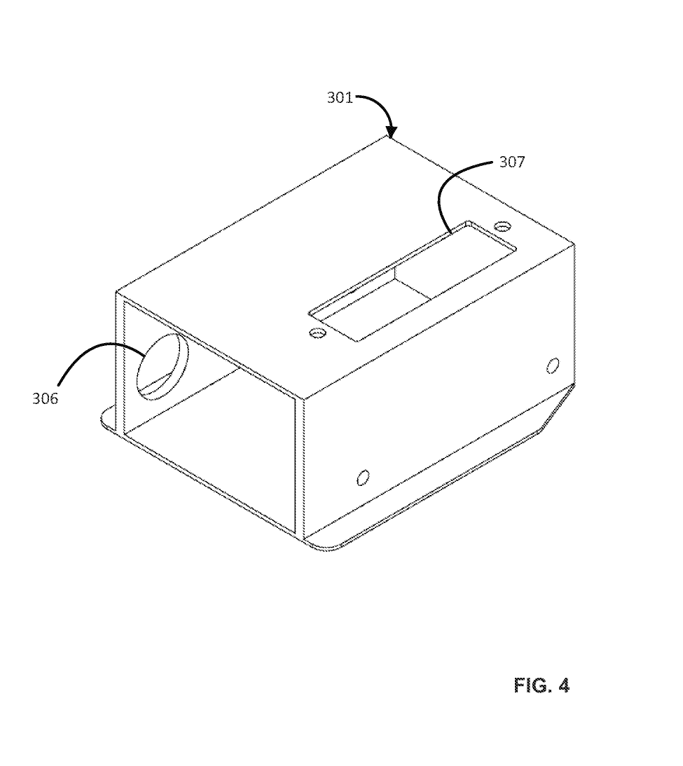

Turning now to FIGS. 3-4, an exemplary housing 301 of an exemplary aspect of an apparatus (e.g., apparatus 101) is illustrated. The housing 301 can comprise one or more first openings 306 to allow accessory ports 106 to be in communication with accessory plugs. The housing 301 can comprise a second opening 307 to allow a user to have access to the one or more circuit protection blocks 107 in the fuse block.

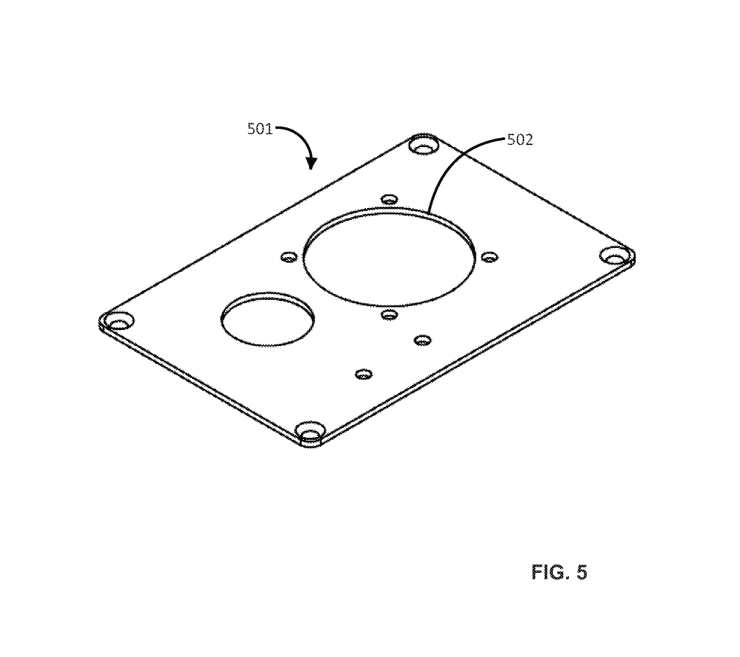

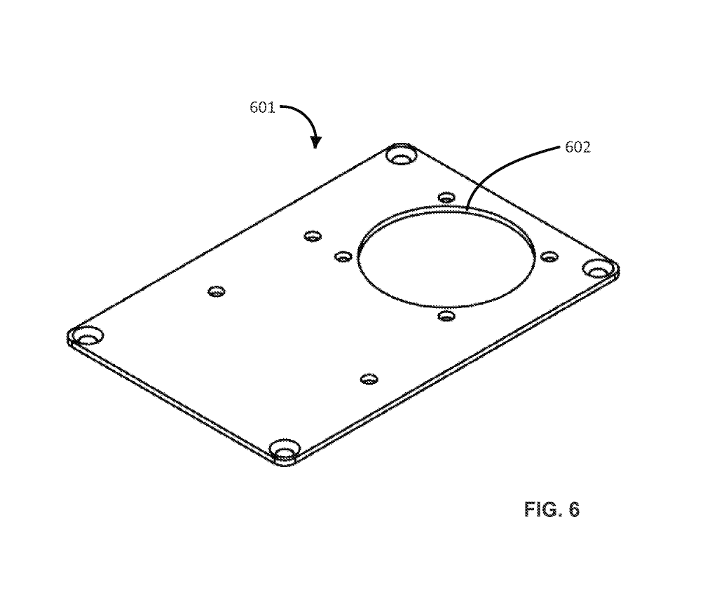

Turning now to FIGS. 5-6, exemplary aspects of complementary components 501, 601 are illustrated. The complementary components 501, 601 can be disposed adjacent housing 301 and/or can be coupled thereto in order to at least partially enclose a space within the housing 301. The complementary components 501, 601 have an opening 502, 602 to allow the vehicle interface 102 of the apparatus 101 to be in communication with the battery of the vehicle.

An exemplary aspect of apparatus 101 can comprise an integrated design that incorporates battery protection 301, heavy duty accessory ports 106, one or more circuit protection blocks 107, heat sink equipment such as cooling fans 111, GPS receiver 104, and safety lighting and switching capability. An exemplary embodiment of apparatus 101 can use a plug and play design, allowing components to be easily removed from the mounting bracket and plug connectors in the event that the components require removal or replacement; this reduces diagnostic troubleshooting time required to differentiate between vehicle problem and/or equipment.

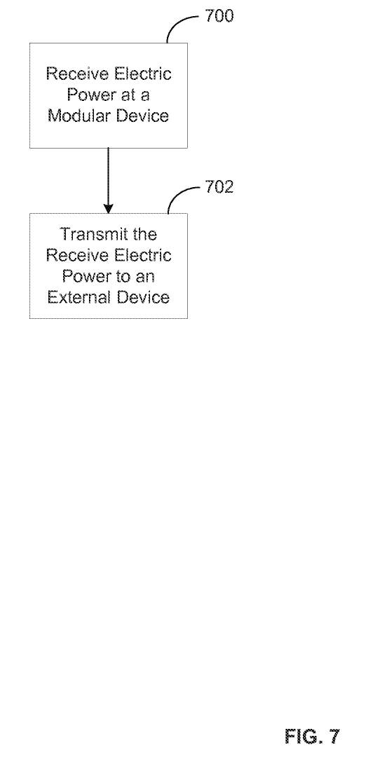

FIG. 7 illustrates an exemplary method. In step 700, electric power can be received at a modular device. The electric power can be received from a vehicle battery. In an aspect, the modular device can comprise a housing. In another aspect, the modular device can have a circuit protection block accessible through a first opening in the housing.

In step 702, the received electric power can be transmitted to one or more external devices. In an aspect, the received electric power can be transmitted via one or more of a plurality of ports. As an example, the plurality of ports can be accessible through a plurality of second openings formed in the housing.

In step 704, one or more characteristics relating to the modular device can be monitored. In an aspect, the received electric power can be monitored. As an example, a signal such as a light can be used to indicate when electric power is being received. As a further example, monitoring received electric power can comprise measuring the received power and providing an output of information relating to the measurement. In another aspect, a position of the modular device can be monitored and/or tracked, for example, via a GPS. In a further aspect, an operational state of one or more of the plurality of ports can be monitored. As an example, a signal such as a light can be used to indicate an operational state (e.g., on/off) of the one or more of the plurality of ports.

In step 706, heat within the housing of the modular device can be managed. In an aspect, managing heat can be accomplished using one or more internal cooling fans. Other devices such as heat sinks can be used to manage thermal energy.

While the methods, systems, and apparatuses have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising:
receiving electric power at a modular device from a vehicle battery, wherein the modular device comprises a housing and the modular device comprises a circuit protection block accessible through a first opening in the housing; and
transmitting the received electric power to one or more external devices via one or more of a plurality of ports accessible through a plurality of second openings formed in the housing.

2. The method of claim 1, further comprising monitoring the received electric power.

3. The method of claim 1, further comprising managing heat within the housing of the modular device using an internal cooling fan.

4. The method of claim 1, wherein the plurality of ports comprise at least one universal serial bus socket.

5. The method of claim 1, wherein the plurality of ports comprises at least one 12 volt socket.

6. The method of claim 5, wherein the at least one 12 volt socket comprises a 15 amp socket.

7. The method of claim 1, further comprising tracking a current global position of the modular device.

8. The method of claim 1, wherein the circuit protection block is mounted on an external wall of the housing of the modular device.

9. The method of claim 1, further comprising indicating one of the plurality of ports is operational with the use of a light.

10. An apparatus comprising:
a housing having a plurality of openings formed therein;
a plurality of electrical components disposed within the housing, wherein one or more of the plurality of electrical components is coupled to a vehicle battery;
a plurality of ports configured to receive an electrical connector, wherein the ports are accessible through one or more of the openings formed in the housing; and
a circuit protection block in electrical communication with the one or more of the plurality of ports, wherein the circuit protection block is accessible through one or more of the openings formed in the housing.

11. The system of claim 10, wherein the one or more of the plurality of electrical components receives power from the vehicle battery and wherein the received power is monitored.

12. The system of claim 10, wherein the plurality of ports comprises a universal serial bus socket.

13. The system of claim 10, wherein the plurality of ports comprises a 12 volt socket.

14. The system of claim 13, wherein the 12 volt socket comprises a 15 amp socket.

15. The system of claim 10, further comprising a global positioning system.

16. The system of claim 10, further comprising an internal cooling fan.

17. The system of claim 10, further comprising a light, wherein the light indicates an operational state of one or more of the plurality of ports.

18. A modular device, comprising:
a vehicle interface receiving electric power from a vehicle battery;
a plurality of ports configured to transmit the received electric power to one or more external devices;
a fuse block; and
a housing comprising a first opening allowing access to the vehicle interface, a plurality of second openings allowing access to the plurality of ports, and a third opening allowing access to a fuse block.

19. The modular device of claim 18, wherein the plurality of ports comprises a universal serial bus socket.

20. The modular device of claim 19, wherein the plurality of ports further comprises a 12 volt, 5 amp socket.
